(19) United States
(12) Patent Application Publication
(10) Pub. No.: US 2008/0215614 A1
(43) Pub. Date: Sep. 4, 2008

(54) Pyramid Information Quantification or PIQ or Pyramid Database or Pyramided Database or Pyramided or Selective Pressure Database Management System

(76) Inventor: Michael J. Slattery, Palm Springs, CA (US)

Correspondence Address: Michael Slattery;Lawrence Branum, 233 W. El Camino Way, Palm Springs, CA, 92264-8321, US

(21) Appl. No.: 11/470,748

(22) Filed: Sep. 7, 2006

Related U.S. Application Data
(60) Provisional application No. 60/714,774, filed on Sep. 8, 2005.

(51) Int. Cl. G06F 17/30

(52) U.S. Cl. 707/103 R; 707/E17.001

(57) ABSTRACT

Embodiments of the present invention allow for methods to catalog, classify and stratify data, producing an optimized and finitely targeted database, database subset or data model, including networks of any scale, and their contents. This would include World Wide Web pages and their objects or resources. Four controls and constraints: Category Target Time and Exclusion, produce a data environment that applies selective pressure to delineate stronger data or targeted data from weaker or unwanted data. A wide variety of free standing application(s), search engine(s), social network(s), database schema(s) and control(s) can all be derived from the inherent flexibility of the information-processing capabilities defined by the patent described herein.

### RELATED APPLICATIONS

This application claims priority under 35 U.S.C. .sctn. 119(e) based on U.S. Provisional Application Ser. No. 60/714774, entitled “PYRAMID INFORMATION QUANTIFICATION: (P.I.Q.), (PYRAMID DATABASE), (PYRAMIDED)”., filed on Sep. 8, 2005., the disclosure of which is herein incorporated by reference in its entirety.

### BACKGROUND OF INVENTION

Inventions in this class include database modeling or schemas that provide for the organization and structure of a database. This class also provides for data or information processing means or steps for organizing and inter-relating data or files (e.g., relational, network, hierarchical, and entity-relationship models). Corresponding methods for the selection of data to be retrieved are included.

Typically, for a given database, there is a structural description of the type of facts held in that database: this description is known as a schema. There are a number of different ways of organizing a schema, that is, of modeling the database structure: these are known as database models (or data models).

Availability and access to computers and the Internet now extends to almost every individual living in a developed country. Of the 6.5 billion individuals now living on this planet, over 1 billion have access to a computer. This collection of computers has contributed to, and has access to, an unprecedented amount of information. Major changes have taken place in society and the world's economy as a result. This information based economy and society requires not only that you obtain targeted information in a timely manor, but that you obtain the “best of class” information as well. This is increasingly difficult to accomplish because of a dauntingly large amount of every type of information available. Although other data resources exist and are addressed in this patent, the primary repository and thus primary source of information and data available today are from the Internet.

Problems have been identified for the effective targeting of the specific information that you may seek and the provider may desire to provide to you. A paramount Internet obstacle is the lack of any unifying information classification system. Two primary contradictory elements also inhibit the seamless exchange of targeted information. The contrast between the very large amounts of information that exists on the Internet, (4200 terabytes of high quality data,) and the very limited amount of information entered into Search Engines as a Query. Fifty percent (50%) of all searches used less than three (3) words for their search query, Twenty percent (20%) used only one (1) and less than five percent (5%) used six (6) or more.

Another problem is accessibility of the information that you may be seeking. The deep web (or invisible web or hidden web) is the name given to pages on the World Wide Web that are not part of the surface web that is indexed by common search engines. It consists of pages that are not linked to by other pages, such as Dynamic Web pages. Dynamic Web pages are basically searchable databases that deliver Web pages generated just in response to a query and contain information stored in tables created by programs such as Access, Oracle or SQL databases. The Deep Web also includes web site(s)/page(s) that require registration or otherwise limit access to their pages, prohibiting search engines from browsing them and creating cached copies. The “deep” Web, consists of specialized Web-accessible databases and dynamic web site(s)/page(s), which are not widely known by “average” surfers, even though the information available on the “deep” Web is 400 to 550 times larger than the information on the “surface.”

Web Crawlers currently map the Internet as they find it, as opposed to producing a logically organized map and rationally and relationally placing the Internet into it. The later greatly facilitates retrieving highly relevant information and quantitatively expands search query terms, without requiring the user to enter more terms than is statistically identified by John Battelle in his book on “The Search”.

Cashed Internet web site(s)/page(s) copies provide large amounts of specific information, including a word inventory, word locations with relevant position relationships to each other. They do not however provide finite categorization under any of the current systems.

Although there are several U.S. patents that contain some analogous elements of this invention as it pertains to databases and database management systems, there are none that incorporate all four rule-sets as defined herein to produce a data environment that applies selective pressure to delineate stronger data or targeted data from weaker or unwanted data. See U.S. patent application Ser. No. 20050222964, Published on Oct. 6, 2005 which describes, “techniques of a method for mapping a hierarchical data format to a relational database management system”, or U.S. patent application Ser. No. 20050223024, Published on Oct. 6, 2005, which provides “Methods, systems and computer readable media for users of a shared database, file system, or other similar software system to browse files or records in the database according to any of the files' attributes in a standard hierarchical tree structure.” Also see U.S. patent application Ser. No. 20060010114, Published on Jan. 12, 2006, which invention pertains to “interaction with multidimensional data”.

Regarding this applications utility in narrowing a search engine response to the users true intent, the current patents in this field also disregard selective pressure as a component to responsive query results. See U.S. Pat. No. 6,513,032, which does not correct this deficiency. U.S. Pat. No. 6,178,419 “A method of automatically creating a database on the basis of a set of category headings uses a set of keywords provided for each category heading. The keywords are used by a processing platform to define searches to be carried out on a plurality of search engines connected to the processing platform via the Internet.” See also U.S. Pat. No. 6,385,602 “An approach for presenting search results using dynamic categorization involves examining search results and dynamically establishing one or more categories of search results based upon attributes of the search results.” Although these patents and each of the following patents contains or alludes to tangential elements of the current invention, none defines methods for inducing selective pressure on the specified database to produce the most accurate response to a search query. None harness the synergistic power of dynamically altering the search substrate by defining and redefining the categories of a search in an interactive process (inter-connectivity) that utilizes web site(s)/page(s) links that occur only within (Link-Cluster-Envelopes) which are defined by (Internet-Category-Data-Models). See also: 20050228895, Published on Oct. 13, 2005; 20020123988, Published on Sep. 5, 2002; 20040122811, Published on Jun. 24, 2004; and 20050149576, Published on Jul. 7, 2005.

There are four primary elements of the current application that are not addressed within any of these patents.

They are:

1) None of the cited patents propose, describe or provide for an idealized, logically organized internet information classification system that would allow for rationally and relationally placing web site(s)/page(s) into a global, systemized, unified information classification system that we describe here as an Internet-Category-Data-Models or ICDM.

2) None of the cited patents incorporates or utilizes the power inherent in determining the inter-connectivity of web site(s)/page(s) within a Link-Cluster-Envelope based upon an Internet-Category-Data-Model.

3) None utilize the rule-sets 1-4, defined herein, (or any defined process(s) to delineate query results, by exerting selective pressure), upon the database to select, migrate, move or highlight the most correct, most targeted, best or most accurate response to the primary database query.

4) Finally none provides for the automatic addition and quantitative expansion of search query term(s) by there heirical inclusion as header-categories within the Internet-Category-Data-Model.

The Internet is uniquely configured to provide the ideal environment for a variety of PIQ Social Network databases. Allowing large numbers of individuals to almost effortlessly participate in transparent community processes where a database of shared information and ideas can be compiled, analyzed and served back to the member participants or community. These shared contributed database communities are often referred to as social networks. Indeed the implementation of elements of this patent would have been unfeasible and unforeseeable prior to the advent of the Internet. The latest figure on registered Internet users was 938,710,929 with 223,392,807 living in the United States.

1. Field of Invention

The present invention relates to the ability to return optimized and/or targeted data in response to a query of a database. The database structure is defined and modeled and the data within is subjected to rule-sets that apply selective pressure, selecting or altering by any information processing means, the (most-fit or best-fit (optimized)), data at one time point or re-evaluating all data in the database over a determined number of time points to obtain the optimized data over time. Optimized in this context can relate to any result desired or derived from information processing. This is accomplished utilizing a computer, personal digital assistant, smart cell phone or other similar electronic device.

2. Description of Related Art

Computer programs all have basic elements in common. The most fundamental commonality is that they all process data to produce a desired outcome or answer a question in response to a query. The data utilized to formulate the answer(s) are stored in a database and quite often the answer(s) are also formatted, organized and outputted in a database format. These databases are repositories of information that facilitates organization and retrieval of specific, categorized, processed and desired or targeted information. Data that populates these databases can be any type of information. Specific wide ranging examples include: Tax information accumulated by the Internal Revenue Service; Patent documents stored by the United States Patent and Trademark Office; Medical Information accumulated by Insurance companies; Company Financial information and there associated stock data accumulated by Stock Exchanges or Brokerage firms; and Image, video and audio data accumulated by the satellite surveillance system implemented by the National Security Agency. Various document types, including Hypertext Markup Language (HTML), and Extensible Markup Language (XML), web site(s)/page(s) database(s), Web based Blogs, Message boards or forum entries, Adobe Acrobat Portable Document Format (PDF files), Office documents (Word, Excel, Power Point, Entourage), and instant-messaging and emails can all be included in these database structures. These examples, in no way define the scope of possible data types, but make it clear that any type of information can be organized and retrieved utilizing a database structure.

One hallmark of a database is it's reference ability and a very common device utilized to obtain specific information from within a database is an index. An index is an intersecting cross-reference or address that provides a shortcut to the specific information that you seek. Just as card files in libraries informed you of the specific location of a specific book within the library. Indexes of databases provide you with specific locations of the information you seek within a database.

The results that you obtain from a search engine are just that, an index or link(s) to the information that you seek, not the information itself. This makes the Internet an easily accessible database of unprecedented scale because the entire Internet is structured and organized utilizing IP networking, TCP/IP (IP Suite), HTML and XML schema protocol(s), data-formats, records, packets and definitions. As the development of the infrastructure of the Internet continues to be refined by the underlying standardized data-models, the Internet will greatly expand and facilitate this database quality.

No form of record management or data formats have been proposed or established for the organization and categorization of information on the Internet. Put another way, there is no recognizable data model for the establishment of a structured relationship of the different categories of information or pre-determined mapping for the placement of web site(s)/page(s) within the Internet's information schema.

The magnitude and scale of the Internet provides a remarkable information/data resource that is expanding at an incredible rate. Locating specific information however, can be challenging. Search engines are designed to search and filter the available information and return a targeted subset of results that match the entered criteria, often called a query. The information/data returned as a result of these querie(s), are often quite large and populated by large quantities of information that are not on point, best of class, or closely related to the defined elements of the search quarry. In most cases the desired information is buried in a reduced, but still dauntingly large volume of information that requires the individual to spend great effort and time reviewing, segregating and selecting the desired relevant information. Advertising based weighted or paid search results further congest the unfettered return of specific relevant responses.

Internet Document retrieval based on indexing of the word inventory within the documents into a document database is also well known. Typically the documents are indexed by creating an index file that records the documents that each word is in. Often there is also a number appended to each word that represents its juxtaposition within the web site(s)/page(s) of the word to all other words on the page. Then when the user inputs a query, the documents that contain one or more words of the query can be quickly identified. However, if the query consists of general words that are not terms of art, or words that have multiple and diverse definitions, the query may produce unsatisfactory retrieval results by either producing few documents that are of interest to the user or producing many documents that are not interesting to the user or both.

Social Networking is a relative new and still emerging Internet innovation. Individuals from around the world can now make communal contributions of information and data to a collective and collaborative database. Wikipedia, a collaborative encyclopedia, is one such example.

Pyramid Information Quantification rule-sets provide an effective environment for multiple participants to contribute to the resources within a shared database, delineating “best of class,” information and allowing the sharing of ranked, stratified or processed information. This new environment extends multiple benefits to the participants that are magnified by the economy of scale realized through the ability of an unlimited number of individuals to participate.

### SUMMARY OF THE INVENTION

A pyramid is commonly defined as a figure with a polygonal base and triangular faces that meet at a common point. This icon was chosen as an exemplary geometric shape to globally name these databases because of its natural constriction of area, no matter what direction you move away from the base. It is also representative of the selective pressure that Pyramid Information Quantification Rule sets impose on databases. This name however is not meant to restrict or define the scope of, or any parameters that a database can adhere to and still be considered a Pyramid database.

The rule-sets as defined below, are collectively referred to as “Pyramid Information Quantification”(“P.I.Q.”), “Pyramid Database”, “Pyramided Database”, “Pyramided” or “Selective Pressure Database Management Systems”, (“SPDMS”)

The PYRAMID INFORMATION QUANTIFICATION (PIQ), system optimizes data, databases or information, utilizing rule-sets to provide organizational structure and selective pressure to accomplish segregating the most valuable information from less valuable information, in real time or over any given period of time. An analogy would be the biological and evolutionary processes of natural selection and selective pressure. Directing the survival of the fittest (data or information) to the top of, or to a pre-determined destination within a database or into another result database. This programmed knowledge management or database management system and its application through the rule-sets described below can be applied to any information, database or data source.

There are multiple contributing factors that make this possible.

Pyramided Applications, Databases, Database Applications, Web Search Engines, Message Boards, Forums, Blogs or Social Networks can utilize large numbers of individuals and/or informational resources to contribute to a categorized and prioritized database that will produce small amounts of high quality, relevant data.

There are four principal rule requirements for a database to efficiently function as a Pyramid database. They consists of a: Category Rule-set (Rule 1), Target Rule-set (Rule 2), Time Rule-set (Rule 3) and/or an Exclusion Rule-set (Rule 4), or any combination of Rules 1, 2, 3 or 4, designed to automatically information process, migrate, move, highlight, select or flag a data subset of the specified category database.

One embodiment of Pyramided databases will not require any additional refinements, navigation, filtering or sorting of the data to immediately determine and visualize the most valuable information contained within the database.

The database can be compiled from multiple informational resources, or from a single source or contributor.

One embodiment, would allow all participants who contribute to the PIQ process to benefit from the collective information and wisdom of all participants. It allows individuals to build new knowledge based on existing knowledge from other people's insights, resources, associations, education and affiliations.

One embodiment, would allow the weakest contributor the same benefits as the strongest contributor. Here is a classical case of information being enriched when it is shared and not diminished buy it's utilization.

Pyramid Databases effectively deal with the broadly distributed data, contributed from multiple sources and from multiple computers linked by the Internet, World Wide Web (WWW), local area network(s) (LAN) or wide area network(s) (WAN), into a single, focused, organized and optimized database.

### DETAILED DESCRIPTION OF THE INVENTION

The disclosure of the capabilities and the various embodiments that allow for their functionality are only a few examples of the many advantageous uses of the teaching of this invention. In general, statements made in the specification of the present application do not necessarily limit any of the various claimed aspects of the present invention. Moreover, some statements may apply to some elements or inventive features, but not to others.

### Pyramid Information Quantification Rule-Sets

The provisions of the following Pyramid rule-sets allow for alteration of every parameter that provides constraints in organization and functionality of the selective pressure elements or information processing system(s). This is required to be able to address the disparate types of data, databases and the desired end results of the users. Although the Rule-set descriptions provided here are general in nature, the organizational and structural limitations of the individual rule-sets parameters provide defined and narrow constraints.

Category Database & Rule-Set: Requires that all data within the Category database, respond in the same manor to any or all subsequent rules, instructions, rankings, formulas, algorithms, sorts, electronic manipulation or information processing applied to the database. Specifically, the type of data must be uniform to the point that all data will respond in the same manor once any of the other Rules-Sets are applied to any data residing within the database(s).

Category rule-set constraints can be as simple as defining the dataset as being numeric, alphabetic or alphanumeric. It can extend to a complex combination of data model(s) and information processing that include or exclude data, base upon a unique combination of, but are not limited to, information processing, data matching, text/word/set matching, pattern matching, pattern mapping, statistical scored search, standard search, link-cluster-envelopes, signal processing, cryptology, data-compression, algorithms, neural networks, artificial intelligence, Jaccard's coefficient, Lorentzian fuzzy score, and Bayesian inference technologies.

Category is both the repository of information (database) and a collection of rule-sets governing or processing the data within.

Target Database & Rule-Set: Defines inclusion or exclusion, elevation or demotion of data. When applied to the data within the specified (Category), database. This rule-set is the primary influence, differentiating and delineating data points from one another. Any change in value of the data, from one time point to another, any information processing, can be defined as a change limiting or triggering event causing the migration, alteration or information processing of specific data; data type(s); data element(s); cell(s); web site(s)/page(s) document(s); file(s); object(s); resource(s); or record(s).

A unique complex combination of data model(s) and information processing techniques that include, exclude or process data, based upon a unique combinations of, but, not limited to, information processing, data matching, text/word/set(s) matching, pattern matching, pattern mapping, cryptology, statistical scored search, search, signal processing, Internet-Category-Data-Models, Link-Cluster-Envelopes, Lorentzian fuzzy score, data-compression, algorithms, neural networks, artificial intelligence, Jaccard's Coefficients and Bayesian inference technologies can also be incorporated into the Target Rule-Set.

Target is both a repository of information (database) and a collection of rule-sets governing or processing how the data is applied, compared or processed against the Category database or how the data is selected to be applied against the Category database . . .

Time Rule-Set: Specifies the time, the number of times and any interval of intervening time that the Pyramid rule-sets would be applied to the database.

When applied to the data within the database, this rule would allow that new, changed, updated or refreshed data be ranked or re-ranked (information processed), within the ranking strata already provided by the rule-sets to new or pre-existing data within the database.

Time Rule-Sets can also provide an ageing factor, influencing the information-processing flow to change the ranking or score of data based upon it's time-stamp, date or chronological age within the database. In this permeation, a subset of the Time Rule-Set would become a component of the Target rule-set.

Exclusion Rule-Set: Reduces the total amount of data returned from the collective selective-pressure of the four Rule-Sets. Exclusion factor can be a finite number, a percentage of the underlying Category database, a calculated value or an incremental value that adjust on each application of the rule-sets. This is a factor that reduces the total volume of information or data as it migrates from one strata to another or the total final volume of information returned as results. Myriad factors can be brought to bear on determining the amount of data excluded from moving or being returned via the selective pressures established by the other rule-sets. In many instances this component will be determined by the category rule-set of the source data. It can be determined directly, relational, arbitrary or driven by the goal of reaching a predefined numerical target for the amount of data or the number of records that the user desires returned.

Used in concert, any combination of the four rule-sets: Category; Target; Time; and/or Exclusion can produce unexpected and very valuable results in many highly variable environments.

Each category of information or data can become a pyramid database, the data within controlled by the restraints of the four rule-sets.

The Pyramid or Pyramided database(s) can be described as having one or multiple selective pressure rule-sets (rule-sets 1-4).

Multiple complementary or contradictory, convergent or divergent, rule-sets can be in competition for command of the moving, migration, highlighting, selecting, targeting, flagging or information processing of data within the database.

Multiple databases under the same or different Pyramid rule sets could be combined. Rules restructuring this new, combined, database can be a new and unique rule set or one of the rule sets previously utilized to govern the databases that where merged or combined.

Information within the pyramid environment can be linked to information outside of the pyramid utilizing hypertext links and built in links to outside resources.

The Pyramid Information Quantification process can bring together an unlimited number of individuals, data, data points, databases or informational resources to contribute ideas, concepts, data or specific information, information processing or information processing systems from a predefined category. This information can also be derived from the myriad computer networks and online sources of information that are available, including but not limited to, a pages of text, web site(s)/page(s), e-mails, voice, audio, video, documents, search engines, e-commerce, customer relationship management, knowledge management, database management systems, information filtering, databases, enterprise information portals and online publishing applications as well as individuals and is then able to stratify this information, determining the relative value or strengths of the data. This data optimization, knowledge discovery in databases, and/or database management system(s) and there application through the rule-sets previously described can be applied to any category of information or data source. Data mining, also known as knowledge-discovery in databases (KDD), is the practice of automatically searching large stores of data for patterns. To do this, data mining uses computational techniques from statistics and pattern recognition. These techniques, depending upon the category and the users desired intent or goal are also be utilized within the Pyramid Information Quantification systems.

### Pyramid Internet Information Quantification

One utilization of this invention is to provide more relevant Internet responses to search queries and to produce results that are the true intent of the searcher. In order to utilize the PIQ system for this task the Category database must be formatted and populated (Schema and data modeled), with the appropriate information that will allow the remaining rules to apply selective pressure according to the Target database (the search query), and return very specific and targeted search results.

The Internet-Category-Data-Model (ICDM),was invented for this purpose. The ICDM provides classifications, allowing for the categorization and classification of every web site(s)/page(s) accessible on the Internet, prior to a search. Effectively mapping the Internet and rationally and relationally placing the web site(s)/page(s) and their object or resources into it.

The ICDM has four main divisions or partitions of information within the Internet-Category-Data-Model. Although most effective when utilized together they can each be utilized independently.

As in other search engine results, the returned query can then be re-ranked by outside influences such as page ranking scores, or preferably an embodiment of this invention Link-Cluster-Envelope ranking, Paid search results (advertiser paid results returned first or separate) can also be incorporated.

Category words could be exclude from inclusion are handled in a similar manor depending upon their importance or how critical it is that the header, category, word-set, or words be excluded or the web site(s)/page(s) containing them be blocked from inclusion in the ICDM. X1 would totally exclude the site with this key word from inclusion. X2, X3, X4 . . . etc., would allow the site to be included with decreasing negative incremental weighting.

This process provides for inclusion and exclusion of text/word/sets within each category, sub-division, providing a logical means to narrow and specify a subject matter, subject division or disciplines.

All information on the Internet can immediately be divided into two separate but often overlapping categories. They are information and commerce. This is uniquely distinct from a library where there is nothing available but information and nothing is for sale.

### Internet-Category-Data-Model

1) IDENTIFICATION NUMBERS/DATE: The first division consists of two concatenated ID numbers and a date. The ID's are generated from header selections and web site(s)/page(s) text/word/set(s) inventories.
a) Header Category ID number(s)(ICDM-HID).
b) Web site(s)/page(s) text/word/set(s) inventory Body ID number. (ICDM-BID)
c) Date in a numeric format representing the last time the ICDM was updated.

2) HEADER CATEGORIES: Pre-defined Super-Categories as dependant B-tree catalogs. {C1-C7}

3) BODY TEXT/WORD/SET(S) LIST BY P-VALUE: text/word/set, match lists for the Category and Sub-Categories that are found within the text/word/set(s) inventories of the web site(s)/page(s) themselves. {C8-C∞)

4) CATEGORY MATCHES & WEB LINKS: The fourth is the list of IP address and/or URL(s) that match the following four criteria.
a) All web site(s)/page(s) that match this ICDM.
b) All web site(s)/page(s) that are interconnected or are linked within the ICDM, this produces the Link-Cluster-Envelope.
c) All web site(s)/page(s) ranked by the number of links going out to other web site(s)/page(s) within the Link-Cluster-Envelope. (Portal Site(s) for this ICDM & Link-Cluster-Envelope).
d) All web site(s)/page(s) ranked by the number of links coming into the web site(s)/page(s) from other web site(s)/page(s) within the Link-Cluster-Envelope. (Most Popular Site(s) for this ICDM & Link-Cluster-Envelope).
e) All web site(s)/page(s) from this ICDM & Link-Cluster-Envelope), that are to be blocked from being presented by a browser.

### Internet-Category-Data-Model

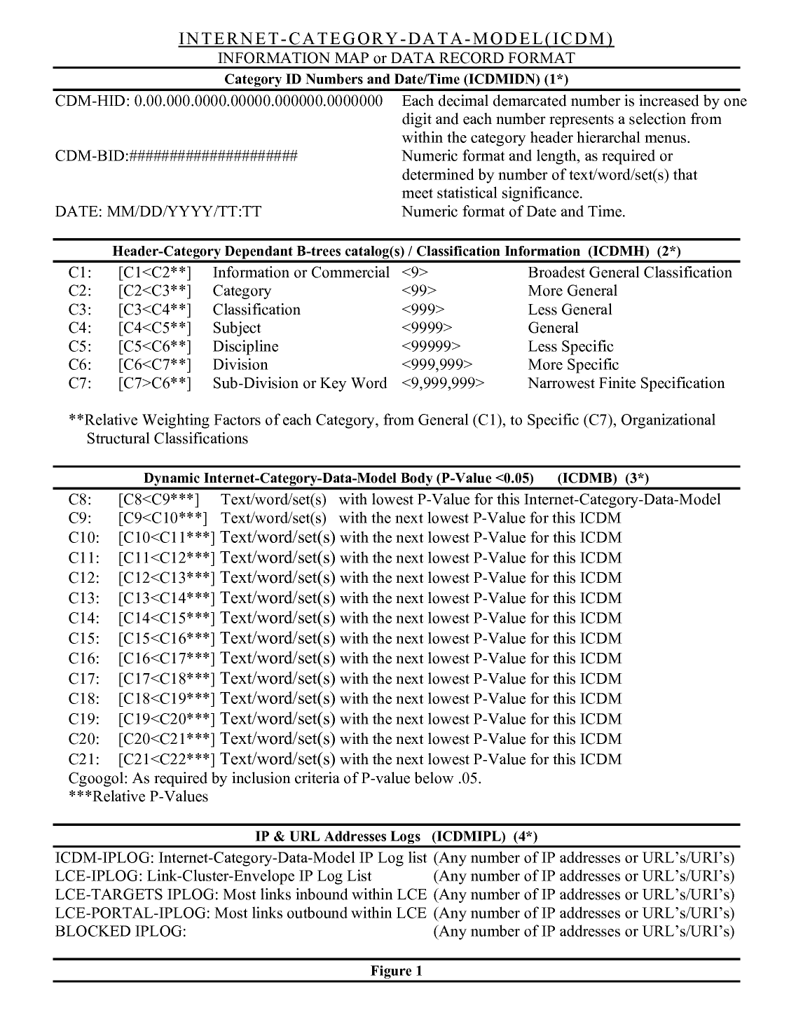

1) IDENTIFICATION NUMBERS & DATE: {RECORD DESCRIPTION}
{See FIG. 1, Division 1}

1a) ICDM Header ID Number (ICDM-HID) consists of the information manually, systematically or automatically appended utilizing hierarchical dependant drop down menu's (catalog B-Trees), to choose within a standardized and highly structured categorization text/word/set(s) list and system. Providing seven levels of classification terms that are all associated with individual numbers. The numbers are concatenated to produce a finite ID number. The classification terms range from general to specific.

1b) ICDM Body ID number (ICDM-BID) consists of the web site(s)/page(s) text/word/set(s) inventory and is derived by a formula that includes a specific number associated with each text/word/set(s) and the category level (C7, C8, or C19 etc.), that the text/word/set(s) is determined to reside at. The statistical significance for the occurrence rate of each individual text/word/set(s) within the ICDM will be determined. The lower the P-value, the higher the statistical significance, the lower category level number that will be assigned to the text/word/set(s) and the higher it will be placed in the resulting ranking. It is important to note that this requires that every word of every language be assigned a unique number.

1c) Date allows for the determination of the last time the ICDM was updated using two digits for the month, two digits for the day, four digits for the year and four digits for the time of day in the 24 hour format.

2) HEADER CATEGORIES {RECORD DESCRIPTION}:
{See FIG. 1, Division 2}

2) Header-Categories are first seven (7) category heading terms, (C1-C7).] Each ICDM Header would be a dynamic set of delineated parameters (words list). Because a web site(s)/page(s) would be placed into this Internet-Category-Data-Model, the Internet-Category-Data-Model Header could contain words that the web site(s)/page(s) did not. The ICDM Header provides the umbrella information that determines the basic header category information envelope. They are: 1) Informational or Commercial: 2) Category; 3) Classification; 4) Subject; 5) Discipline; 6) Division and 7) sub-division or key word. The order, names and contents of these catalog lists can be changed. The purpose cannot. They are provided to give the ICDM Header an organizational structure that ranges from general (C1) too specific (C7). for a given and defined Internet-Category-Data-Model. These catalogs of lists, provides categorization and informational envelope that all additional information fits within. They are a series of dependant b-tree catalog list, each catalog selection further defining the subsequent catalogs that would be displayed or accessed. They produce a simple and very powerful method to quickly classify the contents of the specified web site(s)/page(s).

3) WEB PAGE WORD LIST BY P-VALUE {RECORD DESCRIPTION}:
{See FIG. 1, Division 3}

3) The third is the web site(s)/page(s) text/word/set(s) inventory that will both include and exclude all web site(s)/page(s) in or out of a category. It is also the Category division against which the Target is quarried. A word-set is two or three words, grouped together, that have no words between them other than stop words. Word-sets and words are ranked by their statistical significance for there occurrence rates within the Internet-Category-Data-Model, and provides them with a p-value. Three word-sets with the lowest p-value are considered to be the most powerful indicator of the concept conveyed by those words matching the category defined by the header-categories. Two word-sets are the next most indicative of this inclusion. Finally individual words are listed as long as there p-value indicates that there is statistical significance in there inclusion. Normally a p-value of greater than 0.05 indicates that the association could be random and an association of less than 0.05 indicates that it is unlikely to be random. A p-value of 0.01 or any smaller number than 0.01 would be indicative of very high confidence that the word was included with the text inventory of almost every web site(s)/page(s) included in the ICDM. Basic to this concept of categorization is the following two statements. Human thought and human logic are structured visually and intellectually by the same organizational structures, words, stringed together to form sentences. “There are approximately three words to convey any concept or idea, with roots from the Latin, Greek, Germanic and Saxon tongues”.

4) CATEGORY MATCHES & IP/URL/URI LINKS {RECORD DESCRIPTION}:
{See FIG. 1, Division 4}

4) Finally the there are five IP/URL/URI address lists. All web site(s)/page(s) within the list within this division are ranked according to their statistical significance scores derived from their text/word/set(s) inventories occurrence rates. Web site(s)/page(s) that had the most text/word/set(s) included with the lowest p-value scores would be listed first. The first list is all of the web site(s)/page(s) that are matches for the current configuration of the Header Categories and Sub-Categories (C1-C7). These are the ICDM Header matches. The second is the IP/URL/URI address's that form the ICDM, which link to one or more web site(s)/page(s) within the ICDM. That constitutes the Link-Cluster-Envelope. The third is the web site(s)/page(s) that have the most links back to themselves from within the Link-Cluster-Envelope. The fourth is the web site(s)/page(s) that have the most links emanating from them to other web site(s)/page(s) within the Link-Cluster-Envelope. The fifth is a blocking list of web site(s)/page(s) within the ICDM that should never be produced to the browser from this ICDM. An example, which is not intended to limit the scope, focus or utility of this patent application, of a proposed ICDM data record format is provided in FIG. 1.

Because search query words that matched the text/word/set(s) inventory of an ICDM would be segregated by the ICDM Header categorization, the optimization, refinement or focus of the returned results would be as if the Category Heading words had also been entered into the search query. This would produce search results that would seem to understand the true intent of the searcher.

What this process accomplishes, is to backload the human and/or machine intelligence into an ICDM. By predefining the category and subject of what the web site(s)/page(s) is about, and incorporating that into the ICDM, it allows for serving that information envelope back as a component of the response to a query, when a search is accomplished and matched within a ICDM's text/word/set(s) Body inventory and within a Pyramid database.

### Automatic Internet Web Site(s)/Page(s) Categorization

Establishing Header Categories for every possible Internet site, web site(s)/page(s), document, element, object or resource would be a nearly impossible task if the process did not contain some method for automation.

That task is easily accomplished by a computer program that automatically and systematically produces every permutation of header category combinations and produces the optimized and statistically significant text/word/set(s) inventory for each Internet-Category-Data-Model.

The fully automatic version of this program would constitute a unique combination of web crawler and a search engine. This “Search-Crawler” would systematically work through every possible combination of the Header-Category, (dependant B-tree catalogs), producing an ICDM and it's associated statistically significant text/word/set(s) inventories for each possible combination.

In order to provide structure and organization to each category, every hierarchal layer is provided with a name. The name implicitly identifies its purpose within the Internet-Category-Data-Model and identifies each layer and allows immediate recognition of its superior or inferior position within the structure of the category. There can be as many sub-categories as required to definitively describe and thus localize the target web site(s)/page(s) that would be appropriate residing within the umbrella or envelope category. The hierarchal nature of the category name system is self-evident. The most superior category level is C1. Inferior categories to C1 are C2, C3, C4 . . . etc. Additionally C1 through C7 are reserved for Header or Super-Category terms or Internet-Category-Data-Model-Header terms. C8 through to as many sub-divisions as are required, are reserved for text/word/set(s) that have been fetched, inventoried and statistically ranked from within the web site(s)/page(s) from all text sources found on or within those web site(s)/page(s).

A search would be conducted on the C7 category (the most specific) and the text/word/set(s) inventory would be determined for web occurrence rates and statistical significance. The resulting text/word/set(s) inventory and/or it's associated IP/URL/URI addresses would then be weighted at 100%.

This would be repeated for C6 through C1 with the weighting factor altered by a corresponding amount (as determined by an optimizing formula or algorithm), as the category heading resolved from specific (C7), to general (C1). Alternatively all Header levels could be weighted the same. The resulting category text/word/set(s), there levels and the numbers generated as a result would produce the Internet-Category-Data-Model-Header Identification Number (ICDM-HID)

All text/word/set(s) inventories (C8-C∞), generated or fetched by the Header category text/word/set(s) (C1-C7), would be compared and analyzed for statistical significance for occurrence rates, incorporating their weighting factors and a final text/word/set(s) inventory would be established for the current ICDM, producing there Internet-Category-Data-Model-Body Identification Number (ICDM-BID).

A Pyramid Search Engine would search on the ICDMB text/word/set(s) inventories produced by the Search-Crawler, (C8-C∞) for the best match and return the ICDM IP's, URL's and or URI's as well as the Link-Cluster-Envelope IP's, URL's and or URI's and any matching paid results while blocking the production of unwanted or undesirable web site(s)/page(s).

If two web site(s)/page(s) have identical ICDM-HID numbers and statistically similar ICDM-BID's, numbers, but did not have any links between the two pages, a ghost link could be established between the two if the IP addresses were not identical. This could effective add very similar or identical content pages to the Link-Cluster-Envelope that where in fact not linked.

### Feedback Loops and Visualization

A second Optimization process can also be incorporated. When viewing a map of the Internet, based upon the commonality of web site(s)/page(s) linked to each other, (including connections between IP addresses, server address, nodes or backbone architecture), the clustering of web site(s)/page(s) by links containing the same, similar or adjacent Internet-Category-Data-Models will occur. This could amount to only two web site(s)/page(s) or two individual web site(s)/page(s) being linked and could extend to hundreds of thousands of web site(s)/page(s) being linked. Please note that this is not “page ranking” based upon the number of links a page may have pointing to it. It is link-clustering base upon links within the same Internet-Category-Data-Model(s).

As each update or refreshing of the Search-Crawler is accomplished, a validation or statistical analysis would be performed on the frequency that each inventoried text/word/set(s) from each web site(s)/page(s) was found. The text/word/set(s) with the highest P-value for relevance (occurrence rate), would produce the text/word/set(s) inventory for the ICDM body. This is also referred to as the “Dynamic ICDM,” because each time the Search-Crawler is run the text/word/set(s) inventory and the word(s) relevance or statistical significance for occurrence could change. This statement is true because as more pages are added to the ICDM the occurrence rate of individual text/word/set(s) could also change. Any change in the text/word/set(s) inventories ranked by statistical significance for each ICDM would also produce a corresponding change in the link-cluster-envelope. Any change in the Link-Cluster-Envelope could change the ICDM. This is referred to as ICDM Gravitational influence.

Within the gravitational influence of the environment produced by the ICDM and Link Clustering-Envelope, “page-rank” takes on an added weight and dynamic value. A secondary ranking of the results subset, using the number of links pointing to a page from within the Link-Clustering-Envelope makes the relevance of those links exponentially more important than standard page rank emanating from web links pointing to a web site(s)/page(s) not pre-categorized by an Internet Pyramid Database. The ranking of these results could be elevated within the search results.

Inversely, a web site(s)/page(s) that has the most links pointing out to other web site(s)/page(s) within the same Link-Cluster-Envelope would be considered a category portal and it's ranking could be elevated within the search results.

Another distinct advantage of building ICDMs is the ability to produce pre-defined environments that would include or exclude any data parameter you or your group may choose. For instance you could easily prevent any site that contained pornography from being categorized. As long as you remained within the specified Pyramided Database for web pages, that was produced, your browser would never intentionally or inadvertently return any site with pornography or any other subject or category of information you want blocked. If you never entered an ICDM for a forbidden or prohibited type of information or category then it simply would not be available within the Pyramid Database to be returned.

Alternatively any special interest group could define categories that would maintain focus and homogeneity of their interest.

A fully automatic implementation of the Pyramid Categorization of the entire contents of the Internet is certainly possible. Search web crawlers currently seek out and inventory the entire contents of the Internet utilizing a sequential or random number that corresponds to the IP address standard. Currently this is a set of four (4) four (4) digit numbers (0000.0000.0000.0000), that produce all Internet Protocol addresses. This addressing convention provides four billion separate and distinct addresses.

There are approximately 988,968 words in the English language. 700,000 of these are scientific and/or technical terms. That leaves approximately 256,000 that are in the English lexicon of use. Only about 100,000 of these are in common and regular use. Most educated individuals have a vocabulary of around 20,000 words. The likely hood of each word having greater than 10 statistically significant correlations is unlikely.

Applying the same techniques as the traditional web-crawler you could randomly or sequentially build ICDM using every word combinations and index the resulting pages. This would produce between Ten million (10,000,000) and One hundred million (100,000,000) Category Combination. As you can see this is a far smaller number than the total number of unique IP or individually addressable web site addresses currently being cashed and cataloged.

The real power of this system does not become evident until a new ICDM is placed into the Pyramid Search Engine database. Here all web site(s)/page(s) on the Internet with a matching ICDM-HID/ICDM-BID numbers would be queried to determine if they linked into or out from this new web site or web page. It either was true each web-site/page would be added to the Link-Category-Envelope. One important element remains. If two web site(s)/page(s) have identical Internet-Category-Data-Model-HID numbers and statistically similar Internet-Category-Data-Model-BID numbers, but do not have any links between the two pages a ghost link can be established between the two if the IP addresses are not identical. This would effective add identical content pages to the Link-Cluster-Envelope that where in fact not linked.

Because the Link-Cluster-Envelope is a collection of web-site/pages that all have at least one connection to at least one other web-site/page within the Internet-Category-Data-Model, it would be possible to utilize a branch tree representation of the links to obtain a visual representation of how the web-site/pages are connected, as well as there geographical IP locations within the architecture of the entire internet. This would produce a subject or category map with a background of juxtapositions of the IP locations for every category of the entire internet. Each intersection of two web site(s)/page(s) would have four numbers associated with it. The Internet-Category-Data-Models-HID numbers of the two web site(s)/page(s) could be considered analogous to a zip code. The Internet-Category-Data-Models-BID numbers could be considered analogous to a street number address. The two numbers would provide finite category identification and IP locations. The four numbers together produce a unique category/content/location intersection identifier for any web site(s)/page(s).

### Manual Internet-Category-Data-Model Classification

In order to manually implement this category system, category models would have to be built. This could be handled by a focused team of individuals that where all employees or it could be accomplished as the work product of a social network. Manual classification is a viable process if the economic value of the resulting information is far greater than the cost of building the database. You only need to look at Google to determine what the possible valuation could be. Manual implementation can be facilitated by producing a computer program that would facilitate manual categorizing web site(s)/page(s). The computer program could be a plug-in to a browser that would allow the navigator to select the currently viewed web site that the browser was displaying and designate it as an Internet-Category-Data-Model. Alternatively it could display an alternative view of the web page with its word inventory and drop down menus to choose the header categories for the appropriate ICDM. Predefined drop-down list would facilitate easily appending as many Header Categories to the new category as would be required. In this case the Heading information would be the first seven categories of the Internet-Category-Data-Model and are designated C1, C2, C3, C4, C5, C6 and C7. When the top most Header Category (C1), is selected between “Commerce” and “Information” all subsequent drop down menus change there selectable inventory of categorization heading subjects. This is true for each drop down menu that is hierarchal lower in the rankings, (C2 is lower than C3) or (C2 is more general and C3 is more specific) and produces a very structured hierarchal environment for the quick and definitive categorizations of each web page. It is important to note that these words may not even appear within the text of the web site or web page that is being categorized

Once selected, as a Internet-Category-Data-Model, the new Internet-Category-Data-Model would enter the Pyramid Database of Internet-Category-Data-Models and the feed back loops between the Internet-Category-Data-Model and the Link-Cluster-Envelope could expand or contract the word list that constituted the category-model. It would also harvest all matching web site(s)/page(s) that match this model. After the selection of all seven category selections (C1 through C7), a number will have been generated via concatenation of all seven numbers associated with their word selections. This number is the Internet-Category-Data-Model-Header Identification Number (ICDM-HID). Additionally the plug-in would enable any inappropriate returned results to be flagged and would clean the Internet-Category-Data-Model of all similar web pages.

Below the Header Categorization Pane would be a second pane. The inventoried list of all words harvested from the currently displayed web page would be displayed in this lower pane in alphabetical order. Each word would be color-coded indicating their source. Title words and web page content words would be in black. Meta data words would be in dark red. Link associated text would be in dark green. Image, Video and Audio files descriptions would be in purple. Database file descriptions would be orange. Document files of any type would be in blue. All of the words would be slightly dimmed. Clicking on a word would add that word to the Internet-Category-Data-Model body and remove the dimming. Alternatively the word could be bolded or highlighted or both upon selection. The order in which the words are selected “weights” them and assigns the order in which they where selected. The first word selected would be C8, the second word selected would be C9 and so on. Each further selection from the inventory of the words most descriptive of the web-page contents, would receive a higher number and a lower ranking. Each word would have a unique number associated with it. That number and it's associated or corresponding C-number would also generate a unique number. All words associated numbers would again be concatenated to produce an Internet-Category-Data-Model-Body-Identification (ICDM-BID). The lower pane would allow the user to switch between two views. The text/word/set(s) inventory view and a normal HTML display of the current web site. These will assists the users in the accurate selection of the text/word/set(s) that are the most descriptive or most accurately define the web site or web page.

After this manual implementation of a web site as a Internet-Category-Data-Model the text/word/set(s) would than be automatically compared to all pre-existing ICDM's and may or may not be revised if it is a close or perfect match to one that already exists.

If this were indeed a unique and new Internet-Category-Data-Model, it would be added to the Pyramid Internet Database and flagged to have the Link-Cluster-Envelope produced. This also could redefine the text/word/set(s) list to different priorities than where manually selected. The automatic feedback between the Internet-Category-Data-Model and the Link-Cluster-Envelope could dramatically expand the total number of web site(s)/page(s) compiled for inclusion into this Internet-Category-Data-Model.

Any single web site(s)/page(s) can be designated and function as an ICDM. Once designated it would automatically “match,” or categorize anywhere from a few, to a few hundred thousand new pages and place them within a new Link-Cluster-Envelope unless there was a perfect text/word/set(s) inventory match. Here all web site(s)/page(s) on the Internet with a matching ICDM-HID number would be queried to determine if they linked into or out from this new ICDM. Any links found would be added to the Link-Cluster-Envelope.

### EXAMPLES IN PRACTICE

### Pyramid Search Engine

### Example 1

Provided here is a general example, which is not intended to limit the scope, focus or utility of this patent application.

### Search Engine Background

When a search engine receives a query, as an example: “Yellow” and “Mustang” and “Convertible”, the words entered are matched including alternate forms such as synonyms, approximate match to capture misspellings and plural and singular forms, against the inverted index list. When the word(s) are matched, the corresponding lists of IP addresses are returned. Since there are three words in this example only the IP addresses that contained all three words would be considered as complete matches and only those would be returned to the browser of the searcher. The results could and probably would be further refined and ranked (which web site(s)/page(s) would be returned first), by many variables. The two primary ranking methods currently employed are, “page rank” and “advertising rank”. Page rank moves a web site returned in a search higher in the list based upon the number of web site(s)/page(s) that have links to it. Advertising rank has many variables, but the primary effect is to move paid advertiser's web pages higher in the search results. Often moving them to prominent positions outside of the normal area where the rest of the results are displayed or by merely placing them in the absolute first position in the results list.

This brief background is important because it is very important to note that although there is an association between the three search query words there is no identification of the “knowledge” that the searcher was requesting.

There are several reasons for this and they are listed below in their order of importance.

All current web crawlers, inverted-indexes and search engines work in concert to map the Internet as they find it, producing very large lists of words and associated IP addresses, but without any contextual reference except the juxtaposition of those words from a single web site page.

Web crawlers and the inverted index that is the product of their harvest are ignorant. “Search engines are ignorant. They don't know what they are listing and the search engine does not know what it, or you, are looking for except for an exact datum word match of the entered search query words.

Contrast that process with a pyramid search engine. The first and most important difference is a categorized and constantly idealized map (database) is produced and all Internet web site(s)/page(s) information is placed into it in a logically structured and well-defined, organizational knowledge hierarchy.

So using a search query example of: “yellow” and “Mustang” and “convertible”, the results of this search would be found within a pre-defined ICDM that would function as providing seven inherent category key words that where never entered by the user, when they originally entered their search query.

The search query (Target) will be matched against the Pyramid Internet I-Category-Database Models (Category) and the resulting match(s) will be produced for the highest statically valid search results containing those words from the body of the ICDM.

Based upon the search criteria and the context of the location within the Internet-Category-Data-Model the search engine would return all of the yellow mustang convertibles that where for sale or described with a listing on the Pyramid Internet database(ICDM). It is important to note that although only three words where entered as a search query (the target), because of the categorization, additional words are automatically included such as “Ford Motor Company”, “Automobile”, “Transportation” and “Commerce”. The combination of categorization, juxtaposition and automatic addition of key words defines, optimizes and targets the resulting search response. Mustang's that are “horses”, would not be returned because of the word “convertible” and “Yellow” within the search criteria would not have returned statistically significant relevance within the Internet-Category-Data-Model of: animals>horses>mustang.

### Pyramid Search Engine Rule-Sets

Category Rule-Set: In this example there would be multiple superior category fields (Header Categories), a category field and multiple sub-categories fields. The category would be text and the structure would be hierarchal. The category would have a predefined category-models that would each be unique.

Target Rule-Set: The Target in this instance would be the search query entered into a Search Engine. It would be a word match of the query within the structure and contents of a specific ICDM.

Time Rule-Set: The time rule-set would be variable in this instance. Refreshing of all Category-Link-Envelopes and thus all Internet-Category-Data-Models could be defined as any time interval depending upon bandwidth and processor power available. It could also automatically refresh the Category Data Models at any point in time where changes to the database where detected.

Exclusion Rule-Set: Exclusion in this case is a factor of the number of “hits” or pages that match the target from within the Internet-Category-Data-Model and maintain statistical relevance. In a search engine environment where the results being returned are from within one Internet-Category-Data-Model and represent the “true intent” of the searcher, the number of “hits” should be a relative small number or all of direct relevance to the searcher and the reviewer will probably prefer to see them all.

### Social Networking: Pyramid Stock Exchange™(PSE)

### Example 2

Provided here is a general example, which is not intended to limit the scope, focus or utility of this patent application.

The stock market is a dynamic and difficult environment to succeed in consistently. Here the participants of a social network, contributing to a pyramided database, applying PIQ rules have an advantage.

In this example a Pyramid database is divided into several layers or tiers for the purpose of stratifying results. Stock picks or entire portfolios that are successful or correct advance upward (move up one tier), within the Pyramid. Those that are neutral stay on the same level and those that are unsuccessful descend to the next lower level. The participants with the most successful stock pick or most valuable portfolio at each 30 day evaluation time point, over the next six months would move by steps, to the top tier of the Pyramid Stock Exchange Database.

At the end of the initial six-month period, the portfolios that migrated into the top tier would be directing the purchase of the clubs discretionary investment funds. These top tier portfolios would also receive a management fee for each month that they where in the top tier position.

Here would be a classic example of all contributors to the collective information within the Pyramid Stock Exchange Database, benefiting from the expertise of the most successful participants within the group.

### Pyramid Stock Exchange Rule-Sets

Category Rule-Set: In this example there would be two data fields for each record. Field 1. User ID that in this instance would be alphanumeric. Field 2. Total Value of the database's individual contributors portfolios which would be a numeric field. These two fields, one numeric and one alphanumeric would constitute a record and this database's category data model and rule-set.

Target Rule-Set: Each portfolio that increased in value would be elevated up to the next level of the pyramid providing exclusionary rules did not eliminate it. Each portfolio that decreased in value would be demoted down one level of the pyramid. Each portfolio that did not change in value would stay on the same level of the pyramid as it was on 30 days ago. Target rule-set in this instance is positive, negative and neutral displacement corresponding to the absolute change in value of the user's portfolio.

Time Rule-Set: Each stock within the portfolio would be evaluated every thirty days for changes in value from 30 day ago. The time rule-set would be 30 days.

Exclusion Rule-Set: For this example we will arbitrarily utilize a 50% exclusionary rule. This would restrain the bottom 50% of the positive portfolios from advancing to the next level. Effectively they would become neutral portfolios.

Everyone participating starts with the same amount of money with which to purchase an imaginary stock portfolio. As is the nature of all pyramids, each layer that is above the last has a smaller area. If it where a physical and not a virtual pyramid, less and less individuals (records), would be able to fit within each higher layer until only a few or one individual could be accommodated within the top layer. Our rule-set constrains the number of individuals ascending up to the next level and allows an unlimited number of people to participate at any one time.

Obviously within the constraints of this example, the dynamic nature of the effects of these rules on the PYRAMID database would push the most successful portfolios further and further upward where they would be vulnerable to succession by two risks. The limitation of space and the necessity to succeed beyond the capabilities and results of this level's peers. As each level's top performers get cut in half by the exclusionary 50% rule, a smaller and smaller number of individuals will be allowed to ascend to the next level.

Selective pressure over time provides a true indication of the stock picking ability of the participants. Two individuals that both had increases in their portfolio of 200% appear to be equals. Participant A's portfolio had increases of 0%, 2%, 23%, 25%, 50%, and 100% over the six months and participant B's portfolio has changes of 100%, 50%, 25% 23%, 2% and 0%. Net percentage change for both individuals would be 200%. But clearly you would prefer that A and not B managed your funds. A is progressively doing better and B is progressively doing worse. That A would be much higher in the Pyramid database than B is a clear example of the survival of the fittest, natural selection or selective pressure inherent in the PIQ system.

The example provided could be utilized in a real world process to provide great benefit to all within the Pyramid Stock Exchange community. Lets consider the Pyramid Stock Exchange a private community with membership fees. Each month's fees are equal to one share of a fund that has equities as it's underlying capital foundation. All stocks to be included in the Pyramids fund are selected by the small number of individuals who have ascended to Level One, the top Tier of the pyramid. All members would thereby benefit from the most successful individuals picking the equities that would constitute the funds value. Each month it may or may not be the same individuals, but the rules of the Pyramid Stock Exchange guarantee that not only that the most consistently successful individuals would be picking the stocks for the fund but also that the most successful of the successful over time would be managing the fund.

Any company that chooses and manages investments for clients, charge fees that range from fixed charges on acquisitions (stocks, bonds or options), to a percentage of the amount of capital managed for their client or members accounts. In this example those fees, whatever they are fixed at, would be shared with the individuals of Level One, with the balance going to administrative and operational overhead. This would provide both financial, psychological, and competitive based incentives to participate and succeed.

An additional incentive for individuals to participate would be a wealth of information within the PYRAMID database. If thousands of members where participating, interrogating the database for the stock most often chosen would be valuable. Interrogating the database for the stock with the biggest gain would be valuable. The list of stocks chosen by the Level One Pyramid portfolios would be valuable. The list of stocks within the portfolios with the greatest net gain for the month would be valuable. The best performing portfolios on every level would be valuable information. The process that is utilized for picking stocks would also be valuable information. Are fundamentalist more successful than technicians or trend followers? All of this information would then greatly benefit the Pyramid community members with their own individual investments inside and outside of the Pyramid Stock Exchange community while they are enjoying the fruits of their personal PSE accounts as they increase in equity. A database that consisted solely of stocks with no associated user information or background data could be segregated by similar methods as well.

To summarize this process, 1,000 members would be contributing capital and stock selections and 10 individuals would be picking stocks that are purchased to be included in the Pyramid Stock Exchange fund. All 1,000 would equally benefit and all 1,000 would have an equal opportunity to be one of the 10 individuals that choose the stocks that are included in the Pyramid Stock Exchange fund. Additionally those 10 individuals will be paid fees at a comparable rate received by market managers of major investment firms. All financial resources utilized for investment purposes would be derived from member fees, profits or an increase in the value of the underlying equities. Risk management would be diligently applied via volatility assessment and money management protocols.

Divesting or selling stocks would be a relatively simple process that would entail a separate Pyramid that represented only the actual positions or holdings of the Pyramid Stock Exchange. Here the Target rule-set would include diversification, money and risk management rules that would determine the number of stocks held by the Pyramid Stock Exchange. The Exclusion Rule-set would retain most successful stocks within the Pyramid Stock Exchange. Those that fell below the Target rule set and Exclusion Rule-set would be sold.

### Drug Development and Design Pyramid Database

### Example 3

Provided here is a general example, which is not intended to limit the scope, focus or utility of this patent application.

To provide another example that is as diverse as possible consider a group of scientist designing a drug. Each scientist would contribute a set of drug candidate molecules designed to interact with a molecular target. The most successful library would move upward in the PYRAMID. All scientists would then have the benefit of interrogating the PYRAMID DRUG DATABASE to redesign their library based upon the most successful libraries and also the most successful single drug candidate.

As the drugs become more refined, the efficiencies of the PIQ process will push the largest improvements upward without, outside influences (like politics, nepotism or favoritism) having an undue impact. It will also quickly eliminate all candidates that failed or where marginal in their effect. Here again the method for evaluation must be the same for all participants. The screening process must be transparent; it's goals and methods of evaluation common to all participants. The Target Rule-set that defined the selection process in this example could be multiple scientific end points that point toward decreased toxicity and increased efficacy within a pre clinical drug development program. One obvious, but by no means the only possibility would be the binding affinity of the drug candidate with the molecular target.

### Pyramid Search Engine Rule-Sets

Category Rule-Set: In this example the category would be the molecular target that the drug was required to activate, inhibit or bind to.

Target Rule-Set: Here the target is the new drug candidate. It would be identified by an ID tag with it respective target binding affinity.

Time Rule-Set: The time period would allow for each group of scientist to redesign or modify their drug candidates, test them and re-submit the results.

Exclusion Rule-Set: For this example we will utilize a 90% exclusionary rule. In drug development you are targeting only the most successful candidates. This would restrain the bottom 90% of the positive drugs (drugs that showed better binding affinity from the last round) from advancing to the next level. Effectively they would be restrained with the drug candidates that showed no improvement or no decrease in binding affinity.

### Competitive Bidding PIQ System

### Example 4

Provided here is a general example, which is not intended to limit the scope, focus or utility of this patent application.

Competitive bidding is a dynamic and critical component of both our government and the commerce of the world.

Here specifications of a product or service could be defined by the Category Rule-set with the proposals of each Category component provided by the Target Rule-set. Price, specifications, time to delivery, after-sale level of service, warranty and parts of the given product or service could be incorporated within the Target Rule-Set.

Here the Pyramided Database would add a very dynamic nature to the competitive bidding process, feeding back valuable information to both the purchaser and the vendors.

As the bidding process progresses, it would be possible for the purchaser to refine design parameters such as source materials or capability envelopes and foster or impede developing trends viewed in the database over time.

For instance, if a defense contractor observed that a materials requirement such as the use of the metal Titanium was a limiting factor in producing cost effective bids, but the use of that metal was not critical to the mission or design criteria in the item up for bid, they would then have the flexibility to change that requirement to a less expensive metal within the Category Rule-set. All bids would be immediately re-ranked and all vendors would have the opportunity to alter their bids at the next time point.

Because of the dynamic and community nature of a Pyramid Database the constantly changing nature of the data as it is updated at each time interval (Time Rule-set), it would enable each competitive bidder to adjust specification parameters as well as price in an interactive manor.

### Pyramid Competitive-Bidding Rule-Sets

Category Rule-Set: The category in this instance would include a detailed inventory of the design constraints that the client wanted the product or service up for bid to exhibit.

Target Rule-Set: Target in this instance would be the specification that you or your company where proposing in response to each design element described within the category rule-set. Performance, price, warranty, service agreement would all be components.

Time Rule-Set: The time interval in this process could be an incremental decrease of time allotted to re-submit a new bid as the date for the final bid comes closer. So you could conceivably start out with a 30-day time interval which would shorten on the next round to 15 days, then 7 and 3 until you had a final 24 hour period to resubmit you final bid. Category rule sets could conceivably change at each time interval deadline.

Exclusion Rule-Set: Here the company putting up the item for bidding would be able to establish design and price thresholds that would constitute exclusion rule-sets.

### CONCLUSION

The foregoing descriptions of preferred embodiments of the present invention provides illustration and description, but is not intended to be exhaustive or to limit the invention to the precise form disclosed. Modifications and variations are possible in light of the above teachings or may be acquired from practice of the invention.

The scope of the invention is defined by the claims and their equivalents.

What is claimed:

1. A computer-implemented method to produce, structure and organize (schema); producing a (data model) and interrogate, (query), a database, comprised of: a
Category Database and Rule-set (Rule 1); and/or
Target Database and Rule-set (Rule 2); and/or
Time Rule-set (Rule 3); and/or
Exclusion Rule-set (Rule 4); and/or any combination of Rules 1, 2, 3 or 4, designed to accomplish information processing and/or produce an information processing system; hereafter referred to as a Pyramid database or Pyramided database.

2. The method of claim 1, comprising: one or more of the four rule-sets, wherein selective pressure is exerted upon the specified database resulting in an optimized query result.

3. The method of claim 1, comprising: the results of, or product of, any type of Search Engine returning results from a Pyramided database.

4. The method of claim 1, comprising: a Search Engine controlled by any combination of Rule-sets 1, 2, 3 or 4.

5. The method of claim 1, comprised of: a specified database, configured as any shape, size, number of layers, depths, arrays, dimensions, be they contiguous or non-contiguous and containing any data; data type(s); data element(s); cell(s); web-site(s)/page(s); document(s); file(s); object(s); resource(s); or record(s) wherein the contents can be processed or information processed by, but not limited to; any one, any combination of, or all of the following; text/word/set(s) mapping, text/word/set(s) matching, pattern matching, statistical scoring, ranking, search, statistical scored search, signal processing, information processing, cryptology, algorithms, formulas, data compression, neural networks, artificial intelligence, Lorentzian fuzzy score, Jaccard's coefficient and or Bayesian inference technologies.

6. The method of claim 1, comprised of: a database, a database management system, an information management system, a knowledge based management system or information exchange, including selective pressure as defined herein, as a filtering or information-processing system.

7. The method of claim 1, comprising: the Category Rule-Set; restricting and producing a homogeneous data environment, ensuring uniformity of response(s), to any rule-sets (1-4), or to any query(s), by all data within the Pyramid-Database.

8. The method of claim 1, comprising: the Category Rule-Set; wherein the Category database contents are filled by a separate computer program such as, but not limited to the Search-Crawler.

9. The method of claim 1, comprising: the Category Rule-Set; wherein the specified database is any freestanding database, accessible or inaccessible from the Internet, including the Internet and/or regardless of the source or type of the information being stored within the database.

10. The method of claim 1, comprising: the Category Rule-Set; produces an idealized data-model (map) of the Internet and integrates the real world Internet (web site(s)/page(s), text, objects, and resources) into that idealized map through rational and relational organizational structures, such as, but not limited to the Internet-Category-Data-Model and/or the Link-Cluster Envelope.

11. The method of claim 1, comprising: the Target Rule-set; that includes but is not limited to; any one, any combination of, or all of the following; text/word/set(s) mapping, text/word/set(s) matching, pattern matching, statistical scoring, ranking, search, statistical scored search, signal processing, information processing, cryptology, algorithms, formulas, data compression, neural networks, artificial intelligence, Lorentzian fuzzy score, Jaccard's coefficient and or Bayesian inference technologies; configured to return an optimized data query result.

12. The method of claim 1, comprising: the Time Rule-Set; that ranks, ages, includes, excludes or information processes, utilizing time, day, date, intervals of time, repeated intervals of time or variable intervals of time, or in any other manor provides information-processing utilizing an element of “Time” as a component of the Target Rule-Set.

13. The method of claim 1, comprising: the Time Rule-Set; that provides for a specific time, number of times, interval or an infinitely variable interval(s) of time(s) to be defined for applying or reapplying rule-sets 1-4.

14. The method of claim 1, comprising: the Exclusion Rule-Set; that allows for the determination of the total amount of data that will be modified or returned from the specified database.

15. The method of claim 1, comprising: the Exclusion Rule-set; is defined as any number or the calculated result of an algorithm or formula.

16. The method of claim 1, comprising: the Category Rule-Set; defining and/or containing dependant catalog b-tree(s) (C1-C7), comprised of list, containing text/word/set, including but not limited to; categories, subjects, disciplines, classifications and divisions and/or sub-divisions, defining a: Header Category(s); and/or Super-Category(s); and/or Category(s); and/or Sub-Category(s); the combined plurality of all categories and there contents, producing the Internet- Category-Data-Model-Header (ICDMH).

17. The method of claim 1, comprising: the Category Rule-Set; defining and/or containing all p-value ranked text/word/set(s) inventories, generated as the product of the category-level (C1-C7) searches, incorporating a weighting algorithm or formula upon the final Internet-Category-Data-Model-Body (ICDMB), text/word/set(s) inventories, producing a final Internet-Category-Data-Model-Body text/word/set(s) inventory (C8-C∞), from the Internet-Category-Data-Model-Header catalogs or text/word/set(s) list.

18. The method of claim 1, comprising: the Category Rule-Set; wherein the results of the Internet-Category-Data-Model-Header (C1-C7), information/data, are added to the harvested/collected or fetched Internet-Category-Data-Model-Body (C8-C∞), information/data, producing a specific, unique, organized categorized and relational Internet-Category-Data-Model (ICDM).

19. The method of claim 1, comprising: the Category Rule-Set; appending unique identifying numbers through concatenation of the assigned unique identify numbers associated with each dependant catalog b-tree content list, harvested/fetched Internet-Category-Data-Model-Body text list or randomly generated Header text/word/set(s) list, allowing the unique identification of every Internet-Category-Data-Model-Header or Internet-Category-Data-Model-Body and thus every Internet-Category-Data-Model.

20. The method of claim 1, comprising: the Category Rule-Set; wherein a collection of web site(s)/page(s) links have, as a minimum, one other web site(s)/page(s) site/page, linking with it from another site or page, that has a matching Internet-Category-Data-Model (content(s) or ID Log number(s)), thus producing a Link-Cluster-Envelope.

21. The method of claim 1 comprising: the Category Rule-Set; defining and/or containing a feedback mechanism wherein the Internet-Category-Data-Model redefines, refreshes and/or updates the Link-Cluster-Envelope and the Link-Cluster-Envelope redefines, refreshes and/or updates the Internet-Category-Data-Model.

22. The method of claim 1, comprising: the Category Rule-Set; wherein the IP/URL/URI addresses of all web site(s)/page(s) that match the Internet-Category-Data-Model and have link(s) to or from each other, are defined as the Link-Cluster-Envelope.

23. The method of claim 1, comprising: the Category Rule-Set; wherein web site(s)/page(s) site(s) or web site(s)/page(s) page(s) that have the most links to and from them, from within the Link-Cluster-Envelope are stratified, weighted or ranked within the IP/URL/URI log listing.

24. The method of claim 1, comprising: the Category Rule-Set; wherein the specified database, is produced and/or contributed to and/or controlled by a Social Network.

25. The method of claim 1, comprising: the Target Rule-Set; wherein information processing is accomplished including, but not limited to; inclusion or exclusion; elevation or demotion; null or no action, upon the data within the specified database.

26. A computer program with the combined attributes of a Web Crawler and Search Engine, the “Search-Crawler”, wherein it's objects are comprising:
1) automatically and systematically produce every permutation of header category-level term combinations (C1-C7), through hierarchal dependant B-tree catalogs and/or randomly, and/or sequentially generated text/word/set(s) lists;
2) conduct an internet search for each category-level term(s) (C1-C7), and produce an optimized and statistically significant text/word/set/inventory from text/word/sets that have been cashed, inventoried and statistically ranked from within the retrieved web site(s)/page(s) for all text sources found within those web site(s)/page(s), for each category level
3) compare and stratify all ranked or scored, text/word/set(s) inventories generated by the category-level searches by a weighting algorithm or formula producing a final body text/word/set, (C8-C∞), from the Internet-Category-Data-Model-Header contents;
4) the combined Internet-Category-Data-Model-Header information/data, and the Internet-Category-Data-Model-Body information/data, producing the Internet-Category-Data-Model;
5) identify, collect/fetch, rank or stratify by statistical significance and log all IP/URL/URI addresses that fall within the inclusion parameters of the Internet-Category-Data-Model(s);
6) Identify, collect/fetch and log all IP/URL/URI addresses of all web site(s)/page(s) and pages that connect (link) to or from web site(s)/page(s) within the Internet-Category-Data-Model producing a Link-Cluster-Envelope;
7) identify, collect/fetch, link and log all identical web site(s)/page(s) with identical ICDMH and ICDMB contents, without identical IP/URL/URI addresses, and add those links to the Link-Cluster-Envelope;
8) rank or stratify and log or list the link(s) within the Link-Cluster-Envelope with the largest number of outgoing connections (links) within the Link-Cluster-Envelope;
9) rank or stratify and log or list the link(s) with the largest number of incoming connections (links), within the Link-Cluster-Envelope,
10) optimize the ICDM by refreshing the LCE thereby redefining the ICDM;
11) optimize the LCE by refreshing the ICDM, thereby redefining the LCE;
12) to identify and block the production or displaying of any web site(s)/page(s) so designated through any blocking designation technique incorporated within the Search-Crawler,
13) produce a branch tree representation of the links within the ICDM to produce an information/category visual representation or category map of the interconnections of links within the ICDM and/or LCE.

27. The method of claim 27, comprising: object 2; determining the occurrence rates and there single or combined statistical significance (P-value) of each text/word/set(s) and/or each web site(s)/page(s), within the Link-Cluster-Envelope as defined by the Internet-Category-Data-Model.

28. The method of claim 27, comprising: object 3; determining by statistical analysis the p-value of the occurrences rate of text/word/set(s) within web site(s)/pages(s), thereby determining inclusion or exclusion within the Internet-Category-Data-Model.

29. The method of claim 27, comprising: a Category Rule-Set; populated by an internet search-engine, functioning also as a web-crawler and combined with an automatic word-combination generator (all permeations of 2 to 7 word combinations), accomplished sequentially or randomly, wherein the Search-Crawler utilizes the generated word-combinations, instead of Internet-Category-Data-Model-Headers or IP/URL/URI addresses, to map and inventory the internet and populate the Internet-Category-Data-Model-Body.

30. A method for organization and categorization (mapping), web site(s)/page(s), utilizing word(s), groups of words (word-sets), found within the parameters produced by the Internet-Category-Data-Model.
